(19) United States
(12) Patent Application Publication
(10) Pub. No.: US 2026/0230711 A1
(43) Pub. Date: Aug. 6, 2026

(54) GATED CAMERA AND GATE-BASED FOCUS ADAPTION

(71) Applicant: Torc Robotics, Inc., Blacksburg, VA (US)

(72) Inventor: Fridtjof Stein, Ostfildern (DE)

(21) Appl. No.: 19/042,947

(22) Filed: Jan. 31, 2025

(30) Foreign Application Priority Data
Feb. 5, 2024 (DE) DE102024103584.6

(51) Int. Cl. H04N 23/72; H04N 23/67; H04N 23/74; H04N 23/75

(52) U.S. Cl. CPC H04N 23/72; G02B 3/12; H04N 23/67; H04N 23/74; H04N 23/75; G02B 3/14

(57) ABSTRACT

The present disclosure relates to a vehicle comprising at least one gated camera oriented forward in a longitudinal direction and at least one light source synchronized therewith, wherein a liquid lens is arranged in an optical path in front of an image sensor of the gated camera. The present disclosure further relates to a method for operating the vehicle, wherein a focus of the liquid lens is adjusted in a gate-specific manner.

### CROSS-REFERENCE TO RELATED APPLICATIONS

The present application claims priority to German Patent Application No. 102024103584.6 filed on Feb. 8, 2024, and titled “VEHICLE AND METHOD FOR ITS OPERATION”, which is hereby incorporated by reference in its entirety.

### TECHNICAL FIELD

The present disclosure relates to a vehicle comprising at least one gated camera and a method for operating the vehicle.

### BACKGROUND

In the future, automatically driving vehicles, such as trucks and passenger vehicles, will increasingly be underway on freeways and other roads.

Such vehicles locate themselves using sensors (typically lidar, camera, radar) and map data in the existing infrastructure and adjust their driving behavior to other road users measured by the sensors.

These sensors installed for this purpose have measurement characteristics that are determined by the sensor type, the design, and physical boundary conditions. Typically, the installed sensors have different tasks. For example, the lidar measures a traffic-relevant area in front of the vehicle in three dimensions. At the same time, the data from a camera are used to determine the semantics of the scenery viewed and to recognize traffic signs and traffic lights.

Requirements derived therefrom determine sensor parameters such as base width, focal length, aperture angle, pixel density, sensor type (color or monochrome), etc.

So-called gated cameras are known in the prior art. Gated cameras are typically used for night applications.

In night applications, light is typically sent and received back by the camera. It is advantageous to have apertures that are as large as possible in order to capture as many photons as possible and thus resolve weakly reflective textures at great distances. A large aperture also means a shallow depth of focus.

If several gates are recorded with different distance ranges, then a fixed focus is a compromise that results in blurring in some distance ranges. A smaller aperture reduces light sensitivity but provides improved depth of field.

US 2016/0266392 A1 describes a device, a system and a method for microscopy. The apparatus, system, and method include a stage configured to receive an article; an adaptable gradient index acoustic refractive (TAG) lens having a first aspect positioned to image the received article, the first aspect of the TAG lens configured to have an optical power profile according to an operating frequency of the TAG lens; one or more lenses configured to magnify an image of the received article at a viewing point; and at least one pulsed light source configured to illuminate the received article and pulse at one or more points within the optical power profile of the TAG lens.

### BRIEF DESCRIPTION

The object of the present disclosure is to specify a novel vehicle and novel method for operating a vehicle.

A vehicle is proposed comprising at least one gated camera and at least one light source synchronized therewith. According to the present disclosure, a liquid lens is arranged in an optical path in front of an image sensor of the gated camera.

In one embodiment, a camera control module is provided that is configured to adjust a focus of the liquid lens in a gate-specific manner.

In one embodiment, the vehicle is designed as a utility vehicle or bus.

In one embodiment, the vehicle is designed as a semi-autonomous or fully autonomous vehicle.

According to one aspect of the present disclosure, a method for operating a vehicle as described above is proposed, wherein a focus of the liquid lens is adjusted in a gate-specific manner.

According to one aspect of the present disclosure, a method for operating a vehicle as described above is proposed, wherein at least one obstacle is detected utilizing the gated camera.

The solution according to the present disclosure enables a better signal-to-noise ratio with simultaneously improved focus adjustment and improved light output and/or sensitivity. Thanks to the improved image signals, subsequent image processing enables earlier detection and classification of driving-relevant objects in adverse lighting and/or weather conditions.

Higher vehicle operating speeds can be achieved as a result of improved visibility and the associated driving safety.

### BRIEF DESCRIPTION OF DRAWINGS

Exemplary embodiments of the present disclosure will be explained in more detail hereinafter with reference to drawings.

In the figures:

FIG. 1 shows a schematic view of a vehicle with a gated camera on a roadway.

FIG. 2 a schematic view of a liquid lens arranged in an optical path in front of the gated camera.

FIG. 3 a schematic view of an example with three gates.

FIG. 4 a schematic view of a camera arrangement comprising the gated camera, a light source, a camera control module and a detection module.

Corresponding parts are provided with the same reference numerals in all figures.

### DETAILED DESCRIPTION

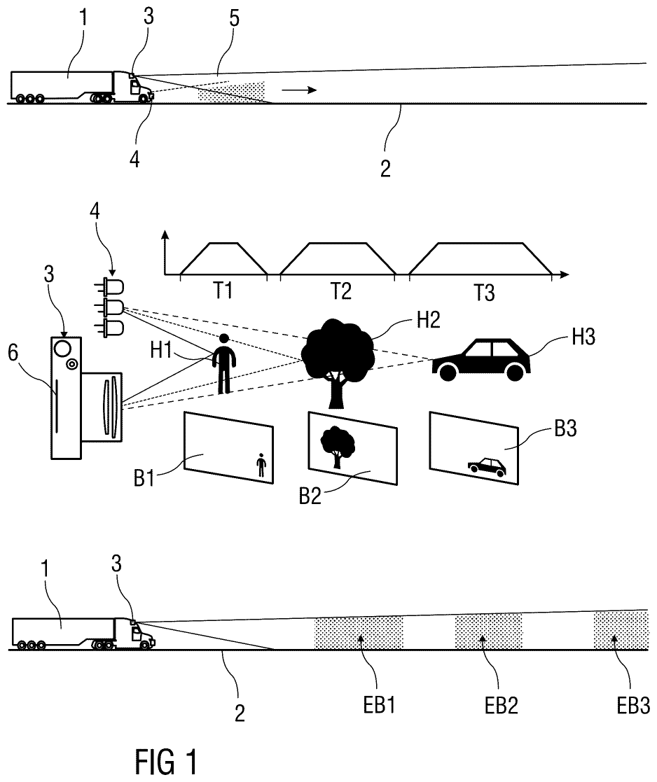

FIG. 1 is a schematic view of a vehicle 1, in particular a utility vehicle, on a roadway 2. The vehicle 1 can be designed as a semiautonomous or fully autonomous vehicle 1. The vehicle 1 has at least one gated camera 3, the viewing volume 5 (frustum) of which can be oriented in a longitudinal direction x, i.e. forward, and at least one light source 4, for example a laser light source, for pulsed illumination of the roadway 2. The light source 4 is arranged spatially offset to the gated camera 3, for example offset in a vertical direction and/or in a transverse direction.

The gated camera 3 (for example from Brightway Vision) combines the light time-of-flight of the emitted light with tight closing times of a pixel gate array of an image sensor 6 designed as a CMOS image sensor, which is time-synchronized with the light source 4, and in this way generates images B1, B2, B3, which are referred to as “gates”. “Gates” are images B1, B2, B3, which represent only the light that has travelled the distance between light source 4 and image sensor 6 within a specified time interval T1, T2, T3 (closing time of the image sensor 6), and thus certain distance ranges EB1, EB2, EB3. By setting a delay between illumination and image capture, the surroundings can be divided into individual images B1, B2, B3, which only depict a certain distance range EB1, EB2, EB3. The gated camera 3 has advantages in the case of atmospheric disturbances, since it implicitly suppresses reflections outside the gates (backscatter avoidance).

The gated camera 3, for example, uses its global shutter technology and illumination by VSCEL light pulses to record 90 images per second.

This high frequency enables new measurement approaches. The terms gate and slice are used synonymously here.

Gated cameras 3 can be used to recognize obstacles H1, H2, H3 on a roadway 2. This makes an important contribution to the safe operation of autonomous vehicles 1. For this purpose, the light sources 4 used are spatially separated from the image sensor 6 and offset, resulting in a shading of the area behind an obstacle H1, H2, H3 on the roadway 2, which appears significantly larger in the image B1, B2, B3 than the actual object or obstacle H1, H2, H3 is shown in the image B1, B2, B3. This effect and the shadow shape due to multiple light sources 4 significantly facilitate the recognition of obstacles H1, H2, H3 in the image B1, B2, B3.

According to the present disclosure, it is proposed to arrange a liquid lens 7 in the optical path of a gated camera 3.

A liquid lens 7 in the optical path allows the gated camera 3 to achieve a gate-specific focus setting when specifically adjusted. Depending on the gate, the focus can be optimally adjusted.

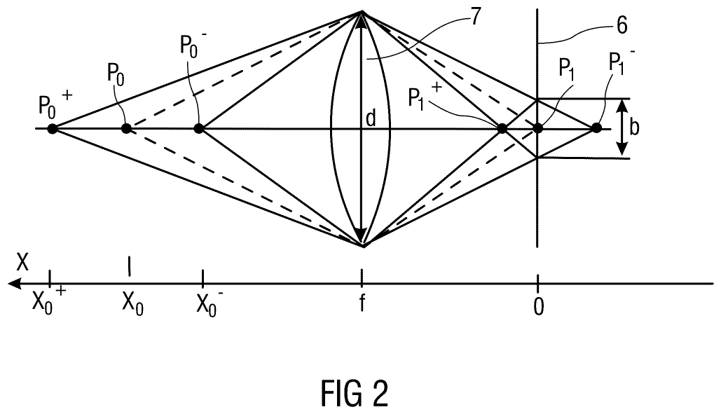

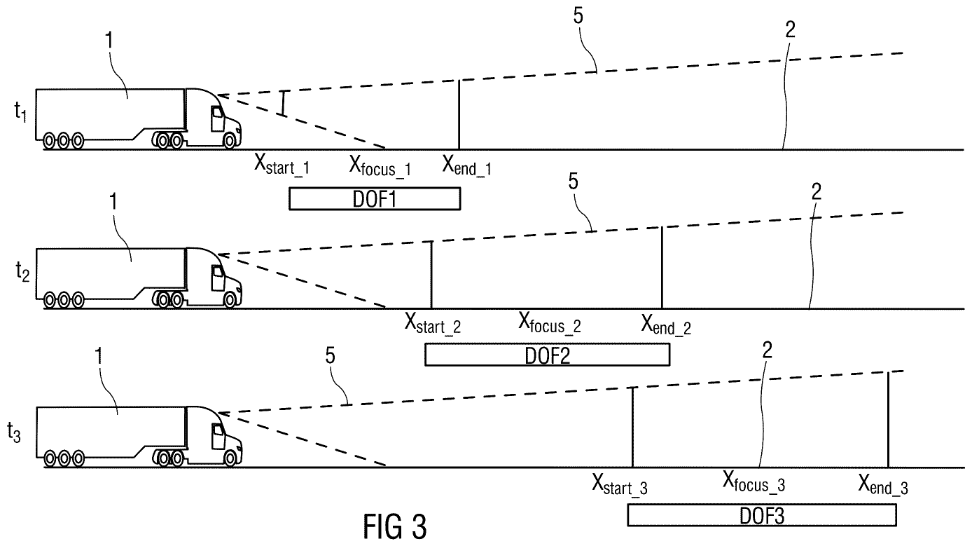

FIG. 2 is a schematic view of a liquid lens 7 arranged in an optical path in front of the image sensor 6 of the gated camera 3 (shown in FIG. 1). FIGS. 2 and 3 include a number of reference characters that represent operational attributes or variables associated with the operation of the gated camera and liquid lens. The characted are defined as follows:

| | |
|---|---|
| b | size of a pixel |
| d | aperture |
| f | focal length |
| ${P}_{1}^{+}$ | $projection of the point {P}_{0}^{+}$ |
| P₁ | projection of the point P₀ |
| ${P}_{1}^{-}$ | $projection of the point {P}_{0}^{-}$ |
| ${P}_{0}^{+}$ | point with maximum distance that is still sharply projected onto |

the image sensor 6

| | |
|---|---|
| P₀ | point with optimal distance that is sharply projected onto the |

image sensor 6

| | |
|---|---|
| ${P}_{0}^{-}$ | point with minimum distance that is still sharply projected onto |

the image sensor 6

| | |
|---|---|
| x | distance from image sensor 6 in longitudinal direction |
| ${X}_{0}^{+}$ | maximum distance of a point that is still projected sharply with |

respect to the pixel size

| | |
|---|---|
| X₀ | optimal distance of a point that is projected sharply |
| ${X}_{0}^{-}$ | minimum distance of a point that is still projected sharply with |

respect to the pixel size

| | |
|---|---|
| x_{focus} | set focal length or set focus of the liquid lens 7 |
| | $Δ {X}_{0}^{-} = {X}_{0} - {X}_{0}^{-} = \frac{{X}_{0} ( {X}_{0} - f )}{{X}_{0} + \frac{fd}{b} - f}$ $Δ {X}_{0}^{+} = {X}_{0}^{+} - {X}_{0}$ |

The depth of field DOF is calculated as follows:

$$DOF = Δ {X}_{0}^{-} + Δ {X}_{0}^{+}$$

For each gate characterized by a start position xₛₜₐᵣₜ and an end position x_{end} with respect to the plane of the image sensor 6,

$$[ {X}_{0}^{-} : {X}_{0}^{+} ]$$

is chosen. The focus of the liquid lens 7 is then set to x_{focus}=X₀.

FIG. 3 shows a schematic view of an example with three gates. At a time t₁, for a first gate characterized by a start position x_{start_1} and an end position x_{end_1} with respect to the plane of the image sensor 6 (shown in FIG. 1), the focus of the liquid lens 7 (shown in FIG. 1) is set to x_{focus_1} in order to achieve a depth of field DOF1 of the gated camera 3 in the range from the start position x_{start_1} to the end position x_{end_1}. At a time t₂, for a second gate characterized by a start position x_{start_2} and an end position x_{end_2} with respect to the plane of the image sensor 6, the focus of the liquid lens 7 is set to x_{focus_2} in order to achieve a depth of field DOF2 of the gated camera 3 in the range from the start position x_{start_2} to the end position x_{end_2}. At a time t₃, for a third gate characterized by a start position x_{start_3} and an end position x_{end_3} with respect to the plane of the image sensor 6, the focus of the liquid lens 7 is set to x_{focus_3} in order to achieve a depth of field DOF3 of the gated camera 3 in the range from the start position x_{start_3} to the end position x_{end_3}.

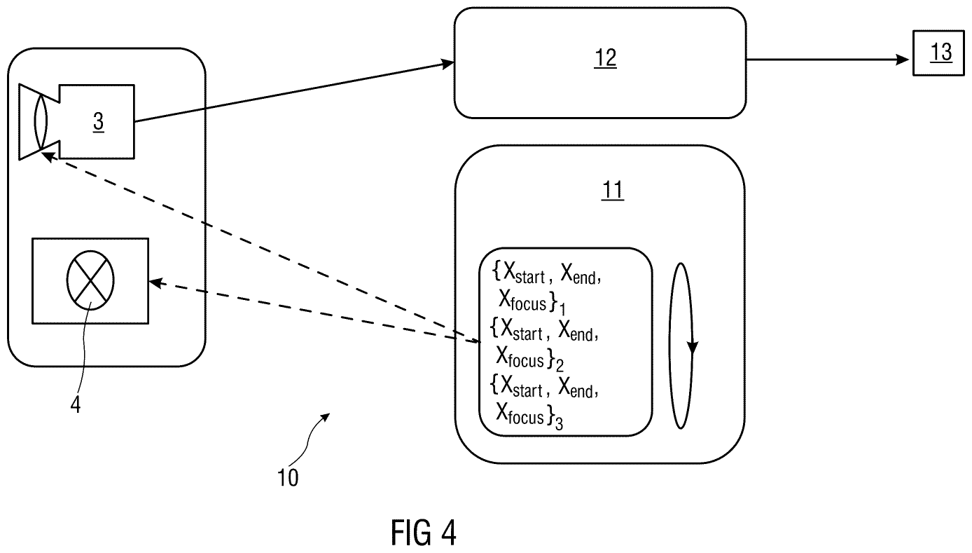

FIG. 4 is a schematic view of a camera arrangement 10 comprising the gated camera 3, the light source 4, a camera control module 11 and a detection module 12 for the gated camera 3, from which detected images can be fed to an image processing unit 13.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A vehicle comprising at least one gated camera and at least one light source synchronized therewith,
wherein a liquid lens is arranged in an optical path in front of an image sensor of the gated camera.

2. The vehicle according to claim 1, the vehicle further comprising a camera control module which is configured to adjust a focus of the liquid lens in a gate-specific manner.

3. The vehicle according to claim 1, wherein the vehicle is a utility vehicle or bus.

4. The vehicle according to claim 1, wherein the vehicle is a semi-autonomous or fully autonomous vehicle.

5. A method for operating a vehicle, the vehicle comprising at least one gated camera and at least one light source synchronized therewith, wherein a liquid lens is arranged in an optical path in front of an image sensor of the gated camera, the method comprising:
adjusting a focus of the liquid lens in a gate-specific manner.

6. The method according to claim 5, wherein the vehicle further comprises a camera control module configured to adjust the focus of the liquid lens.

7. The method according to claim 5, wherein the vehicle is a utility vehicle or bus.

8. The method according to claim 5, wherein the vehicle is a semi-autonomous or fully autonomous vehicle.

9. The vehicle according to claim 1, wherein the at least one gated camera is oriented forward in a longitudinal direction.

10. The method according to claim 5, wherein the at least one gated camera is oriented forward in a longitudinal direction.

11. The vehicle according to claim 1, wherein the light source is a laser light source.

12. The method according to claim 5, wherein the light source is a laser light source.

13. A method for operating a vehicle, the vehicle comprising at least one gated camera and at least one light source synchronized therewith, wherein a liquid lens is arranged in an optical path in front of an image sensor of the gated camera, the method comprising:
capturing, via the gated camera, a plurality of images of a roadway, wherein a focus of the liquid lens is adjusted prior to capturing each respective image of the plurality of images;
determining a shaded area of each respective image; and
recognizing, via the shaded area, at least one obstacle on or proximate the roadway.

14. The method according to claim 13, wherein the light source is physically offset from the gated camera.

15. The method according to claim 13, wherein the vehicle further comprises a camera control module configured to adjust the focus of the liquid lens.

16. The method according to claim 13, wherein the vehicle is a utility vehicle or bus.

17. The method according to claim 13, wherein the vehicle is a semi-autonomous or fully autonomous vehicle.

18. The method according to claim 13, wherein the at least one gated camera is oriented forward in a longitudinal direction.

19. The method according to claim 13, wherein the light source is a laser light source.

20. The method according to claim 13, wherein the vehicle further comprises a detection module for the gated camera, wherein the detection module is configured to feed images to an image processing unit.
